(19) United States
(12) Patent Application Publication
(10) Pub. No.: US 2013/0263786 A1
(43) Pub. Date: Oct. 10, 2013

(54) Compositing apparatus and method

(71) Applicant: SAGINAW VALLEY STATE UNIVERSITY, University Center, MI (US)

(72) Inventors: Edward Charles Meisel, III, Saginaw, MI (US); Doug Butterfield, Auburn, MI (US); Brennan Michael MacMillian, Saginaw, MI (US); Jason Erich Hubenstricker, Laredo, TX (US)

(21) Appl. No.: 13/986,049

(22) Filed: Mar. 27, 2013

Related U.S. Application Data
(60) Provisional application No. 61/686,132, filed on Mar. 30, 2012.

(51) Int. Cl. C05F 17/02

(52) U.S. Cl. CPC C05F 17/0205
USPC 119/6.7

(57) ABSTRACT

A composting apparatus and method utilizing a vessel for receiving organic material which is rotatably supported. In a preferred embodiment, the vessel has a two corrugated conduits of different diameters and the one of smaller diameter is axially aligned inside the larger conduit to move and agitate the material in two different lateral directions. The worm vermicompositing takes place in the inside of the smaller diameter conduit, dropped into the outlet larger conduit where it is dried and collected. In another embodiment, the vessel is fabricated from secured end-to-end at their top ends. The vessel is rotated by an electric motor with a gear reduction drive sprocket engaging a peripheral track on the exterior of the larger diameter conduit. Water can be added during the vermicompositing to make and collect worm tea.

### BACKGROUND OF THE INVENTION

1. Field of the Invention

The present invention relates to an apparatus and method for “vermin” (worm)-decomposition of biodegradable organic materials such as yard waste, waste paper, food waste, and the like. Worm composting requires special requirements in order that the decomposition apparatus and methods do not harm the worms. Mechanical stresses, temperature, aeration, waste type, and the amount of moisture can all affect the health of the worms.

For many years, it has been common practice for gardeners to make compost from leaves, grass clippings, food waste and the like. The material is generally placed in a pile or in a compost bin, which is then periodically agitated. Over a period of time, the organic material will naturally decompose becoming converted into nutrient rich humus. The resulting humus material is extremely beneficial to gardeners as the material can be mixed with soil or spread over the existing soil to provide a protective plant covering, reducing evaporation and protecting plants from heat and cold and also enhances the fertility and porosity existing soil. The compost covering also promotes germination of seeds and plants. Composting is attractive to gardeners for these benefits and further because composting reduces the volume of household waste that is deposited into landfills. Worm decomposition also adds the ability to form “worm tea” that has advantages of its own; like protecting the plants from insects, disease, while also working as a foliar feed, and supplement for soil and plants.

Composting basically is a controlled biological decomposition of organic material under aerobic conditions. The process relies on naturally occurring microorganisms, mainly bacteria and fungi, to break down organic compounds into simpler substances.

2. Description of Related Art

Several methods of composting are used today, either on a small-scale basis by individuals or in larger operations where commercial operators and municipalities conduct waste management facilities. The art of decomposition without use of worms does not apply to vermicomposting and the art relating to apparatus for decomposition without worms likewise does not generally apply to worm decomposition. In-vessel composting is known. In-vessel composting devices offer some advantages including better process control, higher rate decomposition and better odor control. Odor control is a major concern of composting systems. Various in-vessel composting and other type units and other systems can be found in the prior art patents. However, the art does not appreciate the issues and problems involved in vermicomposting. Vermicomposting is essentially the consumption of organic materials by special earthworms known as “red wiggler” worms. The end product is nutrient rich and is called vermicompost in the form of vermicompost and worm castings. When expelled from the worms, worm casts consist of granules surrounded by mucus that hardens upon exposure to air. These granules when mixed into soil slowly organic nutrients. The hardened particles do not readily breakdown so they serve to break up soils providing aeration and improved drainage. Worm tea, which is also rich in nutrients, can also be formed during the vermicompositing process. The most common red wiggler worms (Eisenia fetida and Lumbricus rubellus) put out a by-product called castings. Worm tea is obtained as water runs off or drips through the castings picking up the nutrients of the castings. Aerating also know as brewing will help the beneficial bacteria flourish for putting onto the plants or soil. Worm tea is infinitely richer in nitrogen, phosphate, calcium, magnesium and potash then the upper 6 inches of top soil. Worm tea is not only an organic plant food but it is also a natural repellent for aphids, spider mites, scale and white flies. This product will not kill insects, but repels them with a smell not detected by the human nose. Worm tea is also good for covering large areas such as lawns, orchards, gardens, etc.

The following United States patents teach various methods and apparatus for producing vermicompost: U.S. Pat. Nos. 6,155,447; 6,223,687; 7,029,512; 7,141,169; 7,879,600; 7,964,385 and 7,998,728. It should be noted that none of these patents teach use of rotating vermicomposter apparatus. The following United States patents teach various composting apparatus but for several reasons are not suitable for effective vermicomposting: U.S. Pat. Nos. 3,138,447; 4,193,786; 4,633,535; 5,139,554; 5,244,804; 5,254,472; 5,300,438; 5,661,031; 5,843,769; 6,001,641; 6,071,740; 6,351,855; 7,341,391; 7,371,566; 7,611,891; 7,745,208. Currently a functional all encompassing vermicomposting system was not known. At the present time the process of vermicomposting and separating waste into finished product is done in multiple operations utilizing various types of equipment such as worm beds, worm wigwams, can-o-worms, worm tea collection filtering and aeration, drying beds and a vermicomposting and vermicasting separation mill. The worm bed is a simple concept where waste is composted in wooden beds. These systems incorporate an automated irrigation supply while also having a worm tea collection feature.

Another system, the worm wigwan uses a simple cylinder in which fresh waste is loaded from the top. Worms reside on the top layer where vermicomposting occurs. When the compost is broken down it falls through a grating where it is collected. A third vermicomposting system, the Can-O-Worms, is a smaller scale design of the cylinder system described in the previous paragraph, in which multiple trays are stacked upon each other and fresh waste is loaded and manually irrigated from the top. The bottom tray consists of finished compost and is removed when full, emptied, placed on the top, and then filled with fresh waste to start the process over. This constant cycle utilizes the worm's tendency to migrate to fresh food requiring monitoring and manual labor often.

While the above-described apparatus and methods for composting and for the utilization and decomposition of waste organics are known, such apparatus and methods have not gained large acceptance by homeowners and industrial users for various reasons. The prior systems generally require substantial attention, as for example, the homeowner must periodically turn the material manually in a drum. The devices found in the prior art also often emit objectionable odors and attract flies and other insects. These variables often lead to human management error.

### SUMMARY OF THE INVENTION

Thus, there exists a need for a simple, effective and highly efficient vermicomposting system, which may be utilized, both by the individual gardener or homeowner and also which may be used on a larger scale for municipal and commercial waste treatment systems.

Briefly, the present invention comprehends a composter for residential and commercial use having a circular conduit vessel (inner conduit) within a second circular conduit vessel (outer vessel) that is rotatably mounted while the common the axis of the vessels is tilted a few degrees up from horizontal. The inner vessel receives the organic material, worms and water as required. In one embodiment, the vessel is formed from a corrugated pipe so the corrugations move the material along through the vessel. The vessels are rotated at a preselected speed using a motorized drive sprocket engages a circumferentially extending track on the outer vessel. The apparatus is capable of continuous use and will produce the desired worm castings and worm tea. The apparatus is preferably provided with programmer so that it can be run according to preset protocols.

### BRIEF DESCRIPTION OF THE DRAWINGS

The above and other objects of the present invention will be more fully appreciated from the following description, claims and drawings in which:

FIG. 1 is a perspective view of one embodiment of the composting apparatus of the present invention;

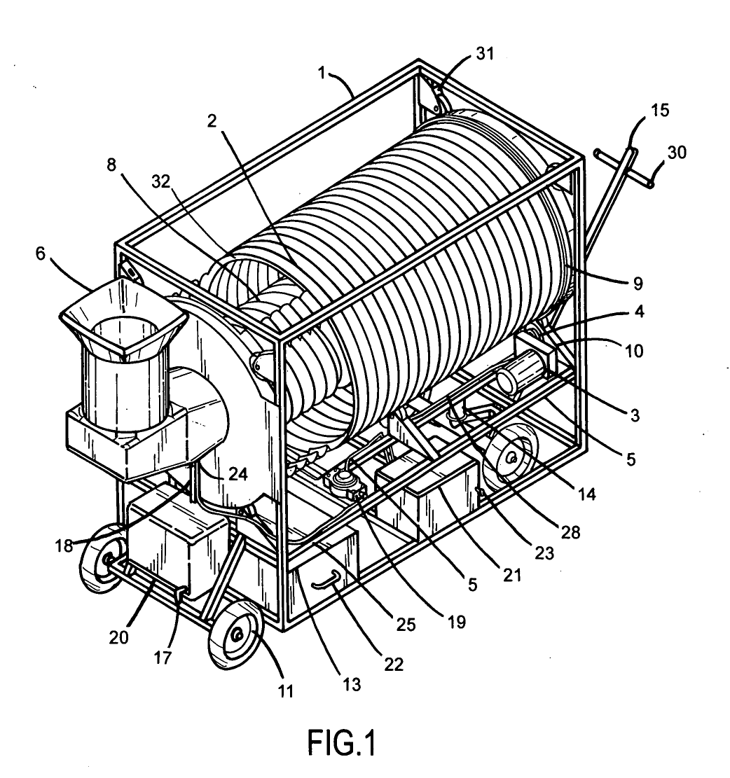

FIG. 2 is an exploded view of the composter apparatus of the invention.

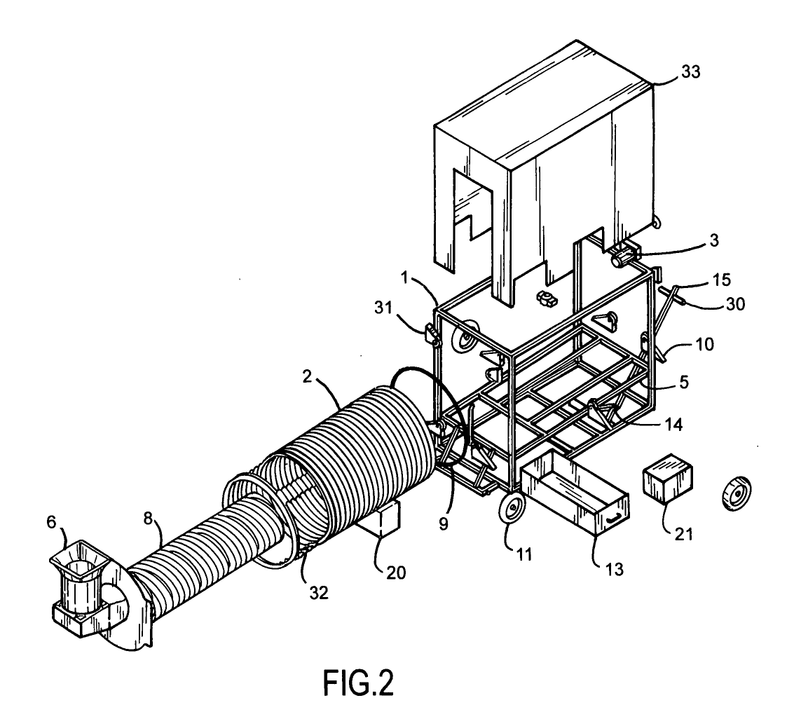

FIG. 3 is a perspective view of the apparatus of FIG. 1 having been boxed in with an outer protective housing.

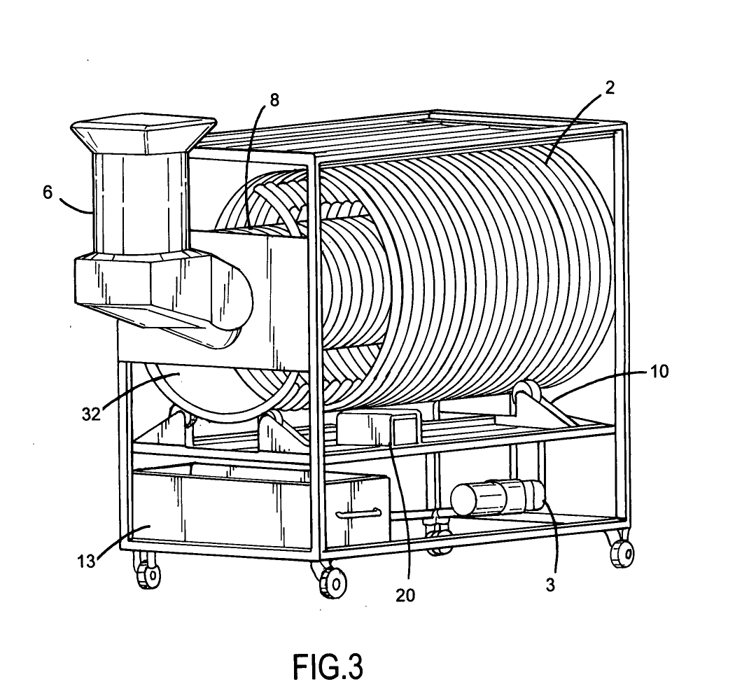

FIG. 4 is a CAD generated 3D view of the apparatus of FIG. 1 with some of the components located in a different position such as the worm tea reservoir.

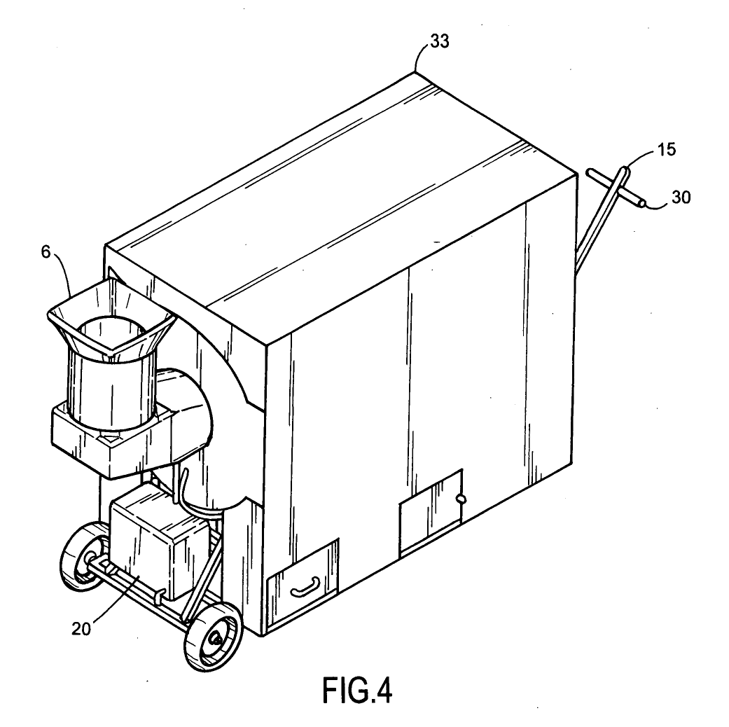

FIG. 5 is a wiring diagram;

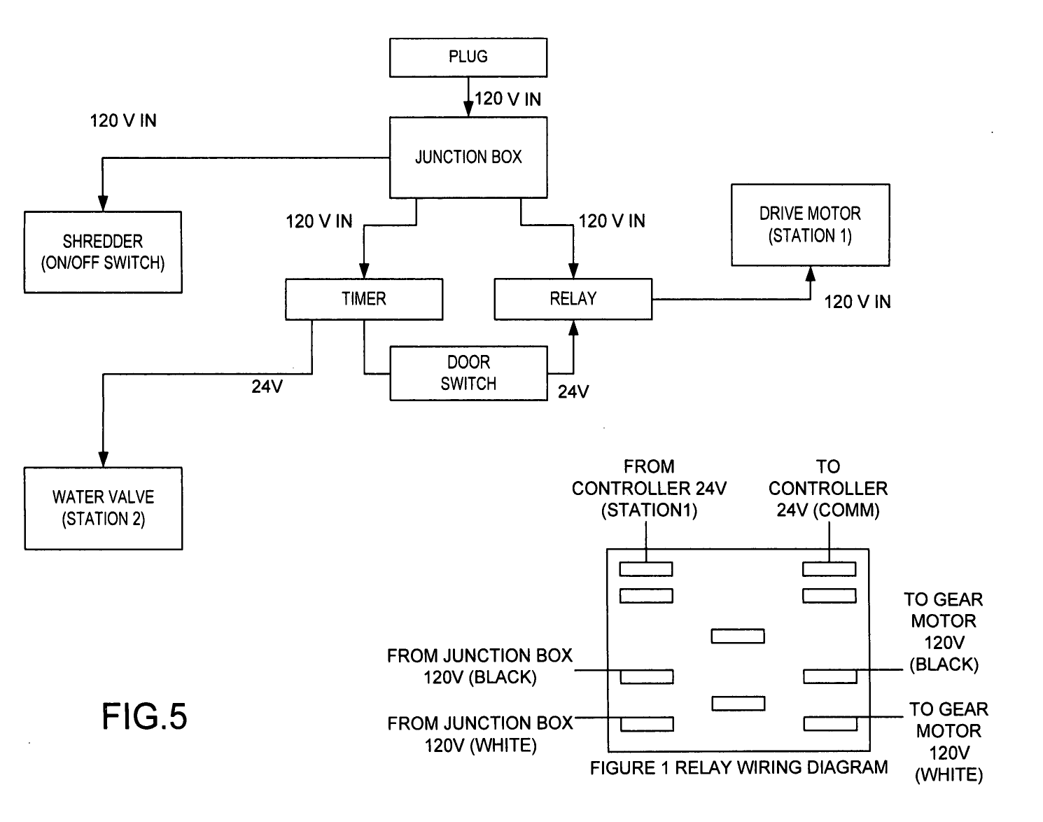

FIG. 6 is a simple schematic diagram illustrating the flow (by the arrows) of the organic material as it is processed through the apparatus of the invention.

FIG. 7-inner conduit partially cut away at the inlet to show position of the optional baffles 34 that assist in moving the organic material into the interior of the conduit for vermicomposting.

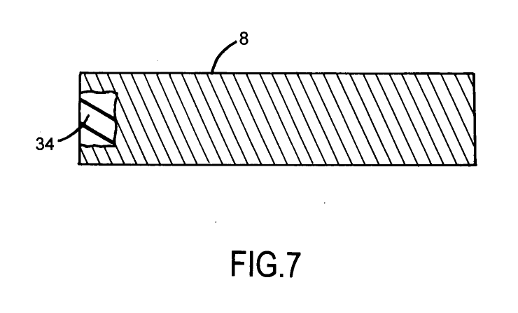

### DETAILED DESCRIPTION

In the drawings the following numbers describe the various elements of the apparatus and method:
1—Outer frame
2—Outer conduit
3—Gear motor
4—Sprocket
5—Mid Frame
6—Shredder
7—no number 7
8—Inner conduit
9—Drive Chain
10—Lower roller
11—Tire
12—No number 12
13—Collection Bin for castings
14—Swivel assembly
15—Pull handle or hitch
16—No number 16
17—Drain valve for worm tea
18—Drain pipe to collect worm tea from conduits
19—Water solenoid
20—Worm tea reservoir
21—Control ox for electrical operations
22—Handle
23—Pull knob
24—Nozzle to add water to the decomposing material in the inner conduit
25—Flexible water tube
26—No number 26
27—No number 27
28—Motor harness
29—No number 29
30—Grip
31—Upper roller
32—Opening at exit end of outer conduit to release castings into collection bin
33—Protective cover for assembly
34—Baffles set at angle to facilitate movement of organic material received from the shredder to in the interior of the inner conduit

An apparatus for receiving and decomposing organic materials employing worms and discharging a compost is provided comprising: a first outer conduit body 2, having a first diameter, a wall with exterior and interior surfaces defining a decomposition chamber, said body being fabricated from a section of corrugated metal pipe of the type having parallel helical corrugations extending around the exterior and interior wall surfaces of the pipe, said body having an inlet at one end and an outlet (opening) 32 at the opposite end; a second inner conduit 8, having a smaller diameter axially aligned and supported within the first conduit having an inside and outside wall defining a worm decomposition chamber, an inlet and outlet portion, the inside wall defining screw helical corrugations projections aligned so as to transport material introduced into the entrance and inside the conduit in the direction of the exit; a frame 1,5 having supporting means (support rollers 10, 31) for supporting said first and second conduits thereon wherein the angle of the common axis of the outer and inner conduits lies on a line slanted upwardly from horizontal from the inlet portion of said inner conduit:drive means (3, 4 and 9) including motor and drive means for rotating said conduits in a predetermined rotational direction and speed that facilitates the movement of the material in the second inner conduit toward the exit of said second conduit at a predetermined rotational speed; and baffles 34 extending axially along the internal wall of the second inner decomposition chamber near the inlet which baffles, 34, along with the interior screw helical corrugations, will mix the organic material and move the material between the inlet to the outlet as the body rotates at a predetermined speed and rotational direction as decomposition occurs.

The apparatus can also include in least one of said inlet and outlet is provided with openings for admission of air into the decomposition chamber. A heat exchange means can also be included extending into at least one of said decomposition chambers for circulating a heat exchange fluid through the said chamber to control the temperature within said chamber. The apparatus also preferably includes a means for adding moisture to the chambers. Optionally a grinder (shredder 6) is provided at a location prior to and connecting with the inlet of said inner second chamber such that organic wastes can be reduced in size before proceeding through the apparatus. The apparatus and process of the present invention will reduce waste being transported to landfills and provide an alternative solution to inorganic fertilizers. The new design can be automated thus requiring little manual labor and combine composting and separating processes into a dual stage design. The apparatus and process is designed to reduce household and industrial waste (such as from restaurants, large cafeterias, and shredded paper located on university campuses) currently allocated to landfills. According to the United States Environmental Protection Agency, 26% of the municipal solid waste stream can be composted and used as a rich organic fertilizer. There are several different systems that can be used for vermicomposting. However, until the invention and all encompassing system did not exist. The system disclosed herein comprises an all-in-one vermicomposting device in which composting and separating finished product occur simultaneously. When implemented this design will reduce the amount of waste being transported to landfills and provide an alternative solution to inorganic fertilizers.

The inner conduit can be affixed and aligned inside the outer conduit with the use of bolt/spacers mechanisms, welded braces or the like.

The problems of the prior art apparatus were identified and the invention is based on resolution thereof based on by several measurable objectives. The objectives define the function, size, cost, features, safety, and performance of the system. The system is designed to specifically meet the following objectives:
Recycle a minimum of 25 pounds of organic waste from the average household waste per week to produce finished vermicompost for homeowner.
Utilize red wigglers to speed up composting process.
Continuously produce and collect worm tea.
Small enough to fit through standard 36″ doorway.
Sufficiently simple to use to sell to public as consumer good.
A composter that will operate on common homeowner utilities. (110 A/C volt single phase 60 hertz, water supply from a standard garden hose,)
Composter can be assembled with common tools found in household.
Programmed automatic operation.
A composter that can be pulled by garden tractor, all-terrain vehicle, or by hand

From the recognition of need and problem definition, the presently described invention was made.

The present invention comprises an all-in-one, automated system that can provide finished compost with the least amount of human interaction possible.

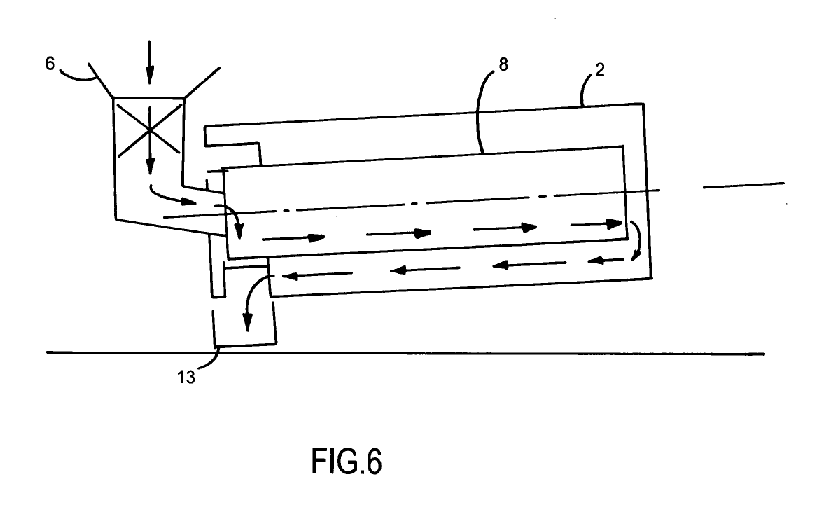

In one embodiment the apparatus of the present invention uses two rotating culvert conduits (one (inner) is centrally located and supported inside the other (outer) and both having a common axis) and both rotating in the same direction The organic waste material flows in two different directions (FIG. 6); upward from the inlet of the inner conduit where it is worm decomposed and then dropped from the outlet of the inner conduit into the outer conduit where it flows downward while it is dried and collected as it exists from the outlet of the outer conduit. The common axis is slightly upward from horizontal. The inner conduit is composed of for a culver that has screw type corrugations and this moves the waste upwards against gravity. The outer conduit can have screw type corrugation but since it slants downward it can also be made of parallel horizontal corrugation. This design utilizes two stages in which the matter is first vermicomposted then separated through a revolving trommel screen employing two rotating culverts to compost and separates the material. The two drums have substantially the same length thus and since the inner drums located within the outer drum the length of the apparatus is reduced by half compared to other two stage systems known in the art. An attached shredder to the inner drum expedites verimcomposting time by reducing the size of the organic wastes. Bubble levels can integrated to make sure the unit is level on the x & y planes, a tester to test the moisture content, light amount, and pH, and a thermometer for temperature determination. Since this apparatus is programmable, everything can be automated allowing the user to only feed in the waste and collect the worm tea, vermicompost, and castings.

The present invention removes serious complications found on known composters and is very cost effective to construct and use. Materials are easily obtainable in various sizes, allowing the design to be scaled up or down depending on a customer's requirement.

Due to its distinct simultaneous two-stage process allows added drying time for the finished compost and eliminates potential “dead spots” within units using agitators where areas can be missed. The slight angle allows ample time for vermicomposting and also for the drying period because of the rates of the corrugated tubing known as culverts. The flow is continuous from beginning to end.

Odor reduction over known composters is also an advantage of the invention.

Specifically, the slow rotating design and minimal pinch points add to the advantages of the invention. The scalability of the invention for large-scale implementation is also possible due to its widely available components in various sizes. Automation helps to remove error.

Certain criteria generated from the problem definition were generated and assigned a weight, based on a 9-3-1 scale. Criterions receiving a weight of 9 were considered highly important, a weight of 3 was considered moderately important, and a weight of 1 was considered least important. After weights were assigned to each criterion, each design concept was rated based on its level of adherence to the given criterion.

The following scale was used in the rating process.
+3: Meets criterion in a manner that is far superior to the datum
+2: Meets criterion in a manner that is superior to the datum
+1: Meets criterion in a manner that is slightly superior to the datum
0: Meets criterion in a manner that is equal to the datum
−1: Meets criterion in a manner that is slightly inferior to the datum
−2: Meets criterion in a manner that is inferior to the datum
−3: Meets criterion in a manner that is far inferior to the datum

The design concept with the highest overall score represents the better vermicomposting system. The criteria and weighting were; Compost(9) Rate(9), Safety(3), Size(3), Cost(3), Ease of Installation(3), Operation/Maintenance(3), Automated(3), Transportable (1) and Appearance(1). Based on the above the present invention was considered to be superior to other alternative designs.

In order to size and safely engineer the invention, standard engineering equations were implemented. To safely design each component, critical loads, torques, and deflections were considered in the engineering process. Realizing the main variable in the system is the weight of compost, design calculations were based on the culverts being loaded to maximum capacity.

Assuming a saturated compost density of 0.033 lb/in³ and weights of 42.2 lb and 73.6 lb for the 15 in diameter and 24 in diameter culverts respectively, a maximum total combined weight of 862.2 lb was determined. To achieve the greatest torque requirement, it was assumed that the culvert was half loaded and rotated 90° from natural resting position. Normal forces were calculated at each of the six rollers and used to determine the frictional force between the steel culvert and polyurethane roller. The coefficient of friction was found to be 0.2. The centroid of the compost was found to be 5.1 inch from the center of the culvert. Moments about the center of the culvert were summed to find the maximum force required to rotate the culvert (196.3 lb). This was then multiplied by the radius of the outer culver (1 ft) to calculate the minimum torque of the drive train. Using this torque and a predetermined rpm of two, power was calculated to size the electric motor. Due to a desired safety factor of three for this key component, a 0.25 hp electric motor was selected, It was calculated that 656.5 ft-lb of torque would be generated from this motor, far surpassing the minimum torque of 196.3 ft-lb determined earlier.

Since the free spin rpm of the motor is rated at 1725 rpm, a gear reduction system had to be implemented to achieve the desired culvert rotation (2 rpm). An in-line gear reducer with a ratio of 144:1 gives a final shaft output of 12 rpm. To achieve the desired 2 rpm, a 4 in diameter sprocket is used to create a 6:1 external gear ratio between culvert and motor.

Maximum load calculations were also used to determine deflection of load bearing frame members. Before calculations were done, the second moment of area of 11 gauge steel tubing was determined to be 0.0555 in⁴. The load of the culverts filled with compost creates a force on the supporting rollers that transfers the force to the lengthwise horizontal cross member pointed out below.

The force on the rollers is calculated to be 143.77 lb, which is used to determine maximum vertical force on the horizontal cross members. The max force on these cross members is found using summation of moments about multiple points on the roller support. Using this max force of 134.8 lb, the max deflection is found this Equation 1:

^{Y}_{MAX}=(PL³)/(48E1) Equation 1

This gives a max deflection of 0.193 inch, which is acceptable in this unlikely case. This same equation is used on the end horizontal cross member sections. Forces on the ends of the lengthwise horizontal cross member are found to be 201.8 lb using summation of moments about an end point. Knowing this, it is possible to calculate the equivalent load acting on the middle of the cross member. This load was used in the deflection equation to determine a maximum deflection of 0.17 in on each of the end horizontal cross members.

With maximum load inside the culvert, summation of moments around two points found the unknown forces on the wheels. Understanding that the invention is symmetrically built this force was then divided by two because it will be distributed to two wheels through the axle.

Computational analysis using a computer aided in the calculation of stresses and deflections as well as the investigation of part and sub-assembly interactions while in motion. To determine how the drive sprocket would react to its non-typical use, the design team simulated the drive sprocket loaded under maximum operating conditions to determine the deflection and stresses within a tooth. As shown in the maximum stress level generated was 212.2 psi, which is well below the yield strength (1.36 psi) of the sprocket material (4150 steel). This confirms the sprocket will be capable of driving the culverts under maximum load conditions.

Another feature of this system is the end products generated from the composting cycle. Rich organic vermicompost and worm tea is produced as a finished usable product. These can be used by the homeowner and on an industrial scale can be sold to consumers.

To better understand the design modifications necessary to generate a functional system, an apparatus was constructed to test and verify the rotating culvert design. Experiments were conducted to establish the greatest angle that the compost would reliably climb the inner culvert. The apparatus used to test the rotating culvert design utilized a simple frame and caster wheels to support a 24″ outer culvert. A 15″ inner culvert was then inserted and centered within the outer culvert where it was secured with bracing. The two joined culverts were then set on the frame and loaded with compost. Wooden blocks were used to elevate the end of the frame opposite to the inlet of the inner culvert and adjust the angle. The culverts were then rotated manually to establish an optimized angle for the design. It was determined that a 7-degree incline was optimal and provided the best flow of compost through the culverts.

Overall dimensions of the apparatus of the example were Length 60″×Width 32″×Height 48″ allowing the system to easily pass through a standard doorway.

The apparatus was designed to run on common household utilities. A standard 110V electric hook up and ⅝″ garden hose can be used to run the system. The system will be completely assembled prior to delivery to end user.

A standard irrigation controller was used to automate irrigation and aeration of the system. This system will allow the operator to manually adjust irrigation and aeration durations to optimize composting conditions. The apparatus can be operated either with a program to provide automated control or the apparatus can be manually controlled.

The apparatus of the invention is an autonomous unit and will require the user to only input waste, empty the finished compost/worm tea, and periodically check the worm habitat. Before any worms or waste are placed into the unit, the following steps should be completed:
1. Find a suitable location for the apparatus.
   a. Caution: To prevent the loss of worms, the apparatus should be kept in an environment that is above 32° F. (0° C.) at all times
   b. The apparatus should preferably be level
      i. One can use two x & y integrated bubble levels as a guide
2. Hookup water supply
   a. The example uses a standard garden hose usually ⅝″ or ¾″
3. Hookup electrical supply
   a. Plug in power cord to any standard 110 A/C volt 60 hertz outlet
4. Program Timing Controller (see section below)
5. Introduce Worms
   a. Place 5-10 lbs of local soil into inner stage to create initial living environment for worms
   b. Open door, place worms (a minimum of 5 lbs) into inner stage Drum)
6. Load waste into shredder
   a. Place waste into load tray on top of shredder. Push waste into shredder with provided plunger.

### Programming the Controller:

### Step 1—Resetting the Timer

Insert 2 AA batteries into the timer. Press the RESET button with a small round tipped object.

### Step 2—Set Time/Date

Turn the dial to TIME/DATE position. Set the current time, date, month, & year using the + or − buttons, followed by the ENTER button to save each setting.

### Step 3—Set Cycle Start Times

Turn the dial to the CYCLE START TIMES position. Enter the start time using the + or − buttons followed by the ENTER button.

### Step 4—Set Station Duration

Turn the dial to the STATION DURATION position. Enter a duration for each station using the + or − buttons followed by the ENTER button to save your setting.

### Step 5—Set Day of Week

Turn the dial to the DAY OF WEEK position. To select the day(s) of the week to run, push the NEXT button until the arrow flashes under the desired day and press the ENTER button.

### Step 6—Auto

Turn the rotary dial to the AUTO position to run the program.

The following contains the recommended initial settings for the timing controller. The operation section outlines adjustments that may be necessary for various input levels.

TABLE 1
Timing Controller Settings
Recommended Initial Programming

| | Duration | Interval |
|---|---|---|
| Aeration(A) | 1 minute | Every 2 days |
| Irrigation(B) | 1 minute | Every 7 days |

### Operating the Apparatus

Loading/Unloading
Loading of the apparatus can occur at almost any schedule that is convenient for the user. Simply turn on the shredder, place waste onto load tray, and force waste into shredder using provided plunger. Once the waste has finished feeding through the shredding unit, turn off the switch. Unloading can occur as often as the user would like, but is required periodically when the collection bin becomes full. The time between required unloading of the machine will vary depending on the amount of waste input. It is recommended to empty compost bin once every week.

Irrigation and Aeration Schedule
Preferably the apparatus requires an initial irrigation and aeration schedule based on expected waste input rate. Table 1 provides guidelines for initial timing. These guidelines may not be perfect due to varying input schedules and waste type being composted. A moisture level meter is provided and the moisture in the inner stage should be checked after two weeks of operation and again if major changes occur in the input levels. If moisture levels are outside of the optimum range (60-90%) the irrigation schedule should be adjusted accordingly. If waste is found to be exiting the machine before it is fully composted the time should be decreased, or if waste is being input is not clearing quickly enough, the aeration schedule should be increased.

Transporting the Apparatus
The apparatus is capable of being pulled by hand or with the assist of a garden tractor or all terrain vehicle. Simply remove handle retention pin to free hitch from resting position. One may choose to pull the apparatus by hand with use of handgrips, or unscrew the handgrips to attach to a hitch with the hitch pin.

### Scheduled Maintenance:

Clean Water Filter (6 Months)
The apparatus water hookup point contains a mesh screen filter to keep contaminants from entering the flow valve or water nozzle. This screen should be removed once every 6 months and checked for contaminants. Clean as necessary.

Clean Worm Tea Filter (1 Month)
The worm tea filter is located on top of the worm tea reservoir and should be cleaned on a weekly basis. Simply lift the pull handle on the filter and remove it from the tea reservoir. The filter can be washed in warm soapy water, or simply rinsed off with a garden hose and replaced into the worm tea reservoir.

Clean Shredder (1 Month)
The shredding unit should be cleaned weekly to ensure odorless operation. Simply unplug the WFARM from the power supply, open the front door, and rinse the shredder chute with a garden hose or pail of clean tap water.

Clean Worm Tea Collection Tray (1 Month)
It is recommended to clean the worm tea collection tray monthly with the shredder. If the tray screen is blocked, simply remove by pulling apart the hook and loop fastener on the bottom of the tray and rinse with clean water. The tray can then be carefully rinsed and replaced onto the worm tea collection tray.

Clean Worm Tea Reservoir and Stone (2 Months)
The worm tea reservoir and air stone should be cleaned once every month. Simply drain the worm tea into a suitable container, remove the threaded end cap from the reservoir, and flush with clean water and replace into the worm tea reservoir.
The following type of waste can be composted in the apparatus of the invention.
This is not an all-inclusive list but some recommended materials for starting out.
Yard Waste
   All forms of plant mater (roots, stems, leaves, etc.)
Boxboard and Cardboard
   Cereal Boxes
   Shoe Boxes
   Paper Towel and Toilet Paper Rolls
   Waxed Milk and Juice Cartons
Paper Products
   Newspaper and Inserts
   Phone Books
   Magazines and Catalogs
   Flyers and Brochures
   Envelopes and Junk Mail
   Printer and Copier Paper
   Notebook and Writing Paper
   Greeting Cards

Additional carbon or nitrogen may be added to the compost as desired with the preferred carbon-to-nitrogen ratio of about 30:1 by weight. Various nitrogen sources may be utilized such as nitrogen containing fertilizer, plants, vegetables, coffee grounds and the like. Carbon can be added in the form of paper, cardboard, leaves and the like. More red wiggler worms, bacteria, and fungus cultures may also be added to accelerate the process. It is also desirable to add water to the vermicompost materials to maintain moisture content of approximately 60% to 90%.

It will be obvious to those skilled in the art to make various changes, alterations and modifications to the vermicomposting method and apparatus described herein. To the extent such changes, alterations and modifications do not depart from the spirit and scope of the appended claims, they are intended to be encompassed therein.

We claim:

1. An apparatus for receiving and decomposing organic materials employing worms and discharging a compost, said apparatus comprising:
(a) a first conduit body having a first diameter, a wall with exterior and interior surfaces defining a decomposition chamber, said body being fabricated from a section of corrugated metal pipe of the type having parallel helical corrugations extending around the exterior and interior wall surfaces of the pipe, said body having an inlet at one end and an outlet at the opposite end;
(b) a second conduit having a smaller diameter axially aligned and supported within the first conduit having an inside and outside wall defining a worm decomposition chamber, an inlet and outlet portion, the inside wall defining screw helical corrugations aligned so as to transport material introduced into the entrance and inside the conduit in the direction of the exit, the outlet being located such that compost in the second conduit will drop into the inside of the first conduit at its inlet location;
(c) a frame having support means for rotatively supporting said first and second conduit thereon;
(d) drive means including motor and drive means for rotating said conduits in a predetermined rotational direction that facilitates the movement of the material in the second conduit toward the exit of said second conduit and at a predetermined rotational speed;
(e) elevation means for selectively inclining said conduits in a predetermined angle position to control residence time within the two conduits and to accommodate loading and unloading; and
(f) baffles extending axially along the internal wall of the second decomposition chamber near the inlet and ending before the worm decomposition begins which baffles, along with the interior screw helical corrugations, will mix the organic material and move the material between the inlet to the outlet as the body rotates at a predetermined speed and rotational direction as decomposition occurs.

2. The apparatus of claim 1 further including heat exchange means extending into at least one of said decomposition chambers for circulating a heat exchange fluid through the said chamber to control the temperature within said chamber.

3. The apparatus of claim 1 including a means for adding moisture to the interior of the second conduit.

5. The apparatus of claim 1 including a grinder located prior to and connecting with the inlet of said second chamber.
